(19) United States
(12) Patent Application Publication
(10) Pub. No.: US 2005/0211632 A1
(43) Pub. Date: Sep. 29, 2005

(54) Base dosing water purification system and method

(75) Inventors: Nan-Hsiung Hung, Jhonghe City (TW); Chang-Chin Chen, Hsin Chu (TW); Hsieh-Sheng Lin, Taipei City (TW); Rouh-Jier Wang, Hsinchu City (TW); I-Hsin Wang, Hsinchu City (TW); Jui-Hua Ting, Sindian City (TW)

Correspondence Address: TUNG & ASSOCIATES;Suite 120, 838 W. Long Lake Road, Bloomfield Hills, MI, 48302, US

(73) Assignee: Taiwan Semiconductor Manufacturing Co., Ltd.

(21) Appl. No.: 10/810,918

(22) Filed: Mar. 26, 2004

(51) Int. Cl. B01D 61/04

(52) U.S. Cl. 210/652; 210/639; 210/663; 210/259; 210/202; 210/263; 210/321.6

(57) ABSTRACT

An improved water purification system including a high-efficiency reverse osmosis (HERO) system and a base dosing system for rapidly raising the pH of wastewater treated in the system. The invention includes an ion exchange unit for initially removing positive and negative ions from the wastewater. A high-efficiency reverse osmosis (HERO) system is provided downstream of the ion exchange unit for further removing ions from the wastewater. A base dosing system is provided between the ion exchange unit and the HERO system for dosing a base into and rapidly raising the pH of the wastewater as the wastewater flows from the ion exchange unit into the HERO system.

### FIELD OF THE INVENTION

The present invention relates to HERO (high efficiency reverse osmosis) water systems used to purify water in various industrial processes. More particularly, the present invention relates to a HERO water purification system having a base-dosing system which facilitates a rapid rise in the pH of wastewater in the purification treatment of the wastewater.

### BACKGROUND OF THE INVENTION

A common drive in various industries is to reduce the quantity of industrial waste, the separate collection and recycling of industrial waste, and the release of industrial waste into the environment. Industrial wastewater contains various waste substances that result from industrial processes. In wastewater treatment, the waste substances are eliminated from the wastewater by operation of a filtration system. Thus, the wastewater is recycled as a clean fluid, and the removed waste substances are disposed of as industrial waste. The cleaned water may be sent back to a natural setting or recycled for further use in industrial processes.

In the semiconductor industry, a large number of processing steps are performed on a wafer substrate to fabricate integrated circuits on the wafer. These processing steps are used to sequentially deposit multiple conductive and insulative layers on the wafer. In chemical mechanical planarization (CMP), a layer on a wafer is subjected to a polishing process in which a silica slurry is applied to the layer as material is removed from the layer. The wafer is rinsed afterward, and the used slurry and rinsing water is discharged as a wastewater. Similarly, after integrated circuits have been fabricated on the wafer, the wafer is subjected to dicing, in which the individual die on the wafer are separated from each other. This generates silicon particles which are washed away with rinse water used to rinse particles away from the die, causing the formation of wastewater. Numerous other processes in semiconductor fabrication result in the generation of wastewater which must be treated prior to either release into the environment or re-use in the fabrication process.

The treatment of wastewater is a complex process, due in part to the constantly-changing nature of the concentration and identities of the contaminant particles to be treated. Additionally, the wastewater flow rate, pH, oxidation potential, concentration of solids and temperature of the wastewater, among other factors, are also variable. Further, many wastewaters contain organic matter including colloids, dissolved ionic matter, dissolved non-ionic matter, surfactants, and suspended solids. Such contaminant materials are present in combination with similar types of inorganic materials. Industrial wastewaters produced during industrial processing, such as electroplating, printed circuit manufacturing and machining, have proven difficult to treat due to the many different types of contaminants present in the wastewater. Despite this difficulty, filtration is a key part of most wastewater treatment plans. Many dissolved materials can be most easily removed if they are converted to an insoluble solid. Pre-existing solids removal is also usually necessary.

The various steps carried out in semiconductor fabrication require a high-quality ultrapure water (UPW) in large quantities. Water obtained from a city water supply includes excessive quantities of impurities to be useful for the fabrication of semiconductors. As the primary component of chemical wafer cleaning solutions and postclean rinse processes, deionized water is the most heavily used chemical in semiconductor manufacturing. Up to 2,000 gallons of ultrapure deionized water are used for each wafer produced in a modern 200-mm wafer process line.

City water has large concentrations of dissolved ions from minerals such as sodium and potassium. For example, salt (NaCl) dissociates into Na⁺ and Cl⁻ ions. These ions are known as mobile ionic contaminants (MICs), which create performance problems in semiconductor devices. Organic materials are another source of contaminant which adversely affect the ability to grow oxide films on wafers. In addition, bacteria in the water shed fragments which may contaminate and cause defects in oxidation, polysilicon and metal-conducting layers. Phosporous emitted by bacteria in processing water may lead to unintended doping of layers. Other contaminants which render city water unsuitable for semiconductor fabrication processing include silica, which decreases the reliability of thermally-grown oxides; and dissolved oxygen, which leads to native-oxide formation on the wafer surface. These contaminants must be removed from the water before the water is suitable for use in semiconductor fabrication processes.

A typical system for purifying city water to deionized water includes a makeup loop and a polishing loop. The makeup loop removes particles, total organic carbons (TOCs), bacteria, microorganisms, ionic impurities, and dissolved minerals from the raw city water. The polishing loop removes the remaining contaminants from the water.

In water deionization, the electrically-conductive salt ions are removed from the water using ion-exchange resins. The deionization process converts the water from a conductive medium to a resistive medium having a resistivity of 18 magaohm-cm at 25 degrees C. Ultrapure DI water is formed by passing water through a makeup loop and a polishing loop, both of which remove ions from the water.

One of the most commonly used techniques to form ultrapure DI water is known as reverse osmosis (RO), which removes small ions such as metallic ions. In reverse osmosis, the water to be filtered flows under pressure across a membrane filter to separate from the water ionized salts, colloids, and organic materials having a molecular weight as small as 150. Reverse osmosis, also known as hyperfiltration, can separate impurities as small as 0.005 microns from the water.

Referring to FIG. 1, wherein a water purification system 10 commonly used to purify city water for semiconductor fabrication processes is shown. The system 10 includes an inlet line 12 provided in fluid communication with an ion exchange unit 14. The ion exchange unit 14 includes a tank 15, in the top of which is provided multiple inlet nozzles 16. An ion exchange resin bed 18 is provided on the bottom portion of the tank 15. Multiple outlet nozzles 20 in the bottom of the tank 15 are provided in fluid communication with an outlet line 22, which leads into a HERO (high efficiency reverse osmosis) system 24.

The HERO system 24 typically includes a housing 26 which contains multiple first stage filters 30 and a second stage filter 32. An inlet line 28 leads from the outlet line 22 and into each of the first stage filters 30. A first stage outlet line 42 leads from each of the first stage filters 30 to a permeate outlet line 36. A second stage inlet line 44 leads from the first stage filters 30 to the second stage filter 32. The permeate outlet line 36 and a reject outlet line 38 extend from the outlet of the second stage filter 32.

City water enters the tank 15 of the ion exchange unit 14 in a continuous flow through the inlet line 12 and inlet nozzles 16, respectively. As the water passes through the ion exchange resin bed 18, large cations and anions, such as Ca⁺⁺ and SO₄⁻, bind to the resin bed 18 and are removed from the water. The partially-purified water passes from the tank 15 through the outlet nozzles 20 and outlet line 22, respectively.

The partially-purified water from the ion exchange unit 14 passes into the HERO system 24 through the inlet line 28. Some of the water flows through the first stage filters 30 and first stage outlet line 42, respectively, and from the HERO system 24 through the permeate outlet line 36. The rest of the water flows through the first stage filters 30, second stage inlet line 44, second stage filter 32 and from the HERO system 24 through the permeate oultet line 36, respectively.

As the water is forced through the first stage filters 30 or both the first stage filters 30 and the second stage filter 32, ions which were not removed from the water in the ion exchange unit 14 are removed from the water. The water which emerges from the HERO system 24 through the permeate outlet line 36 is substantially de-ionized. Ions removed from the water by the first stage filters 30 and second stage filter 32 are discharged through the reject outlet line 38.

The city water which enters the ion exchange unit 14 has a pH of typically about 6˜7. This same pH is maintained as the water leaves the ion exchange unit 14 and enters the HERO system 24. In the first stage filters 30 and second stage filter 32, anions are rejected from the water by negatively-charged membranes. Consequently, hydronium (H⁺) ions remaining in the water are free to react with hydroxide (OH⁻) ions, thereby raising the pH of the water. As a result, the pH of the purified water leaving the HERO system 24 through the permeate outlet line 36 has a pH of typically about 8.5˜10.

The water purification system 10 is useful to purify city water having a relatively high pH of 6˜7 for subsequent use in semiconductor fabrication processes. However, the water purification system 10 is typically unsuitable for the purification of wastewater from semiconductor fabrication processes, due to the relatively low pH (3˜4) of such wastewater.

Assuming a dosing rate of “1” is necessary to raise the pH of water from 7 to 8, the dosing rate necessary to raise the pH from 3 to 4 is 1,000; from 4 to 5, 100; from 5 to 6, 10; from 6 to 7, 1; from 7 to 8, 1; from 8 to 9, 10; and from 9 to 10, 100. Because the dosing rate from a pH of 3 to a pH of 10 varies so sharply, such a pH adjustment is difficult to achieve using the continuous water flow characteristics of the conventional system 10. Accordingly, a system and method is needed for the treatment and purification of wastewater, as well as the raising of the pH of wastewater, for subsequent use in semiconductor fabrication processes. Most preferably, a base dosing system and method is needed for raising the pH of wastewater from about 3˜4 to about 6˜7 prior to entry of the wastewater into a HERO system.

An object of the present invention is to provide a system for the treatment of wastewater from a variety of industrial processes.

Another object of the present invention is to provide a system which is suitable for purifying wastewater for subsequent use in industrial processes.

Still another object of the present invention is to provide a water purification system having a base dosing system for raising the pH of wastewater prior to reverse osmosis treatment of the wastewater.

Yet another object of the present invention is to provide a base dosing system which may be retrofitted to existing reverse osmosis systems.

A still further object of the present invention is to provide a water purification system having a base dosing system which increases the recovery rate of ultrapure water from wastewater.

Another object of the present invention is to provide a base dosing water purification method which improves the quality of water treated using high-efficiency reverse osmosis.

### SUMMARY OF THE INVENTION

In accordance with these and other objects and advantages, the present invention generally relates to a new and improved water purification system including a high-efficiency reverse osmosis (HERO) system and a base dosing system for rapidly raising the pH of wastewater treated in the system. The invention includes an ion exchange unit for initially removing positive and negative ions from the wastewater. A high-efficiency reverse osmosis (HERO) system is provided downstream of the ion exchange unit for further removing ions from the wastewater. A base dosing system is provided between the ion exchange unit and the HERO system for dosing a base into and rapidly raising the pH of the wastewater as the wastewater flows from the ion exchange unit into the HERO system.

As it enters and leaves the ion exchange unit, the wastewater maintains an acidic pH of typically about 3˜4. The base dosing system includes a base dispensing tank which contains a supply of concentrated sodium hydroxide. Before the wastewater from the ion exchange unit enters the HERO system, the pH of the wastewater is raised to about 6˜7 by the addition of base from the base dispensing tank into the wastewater. The HERO system further purifies and raises the pH of the wastewater from about 6˜7 to about 8.5˜10. The resulting ultra-pure and de-ionized water, having a raised pH, is then suitable for use in semiconductor fabrication processes, for example.

The present invention is further directed to a method for purifying wastewater. The method includes removing ions from wastewater in an ion exchange unit, raising the pH of the wastewater from about 3˜4 to about 6˜7, and distributing the wastewater through a HERO system to further remove ions from and purify the water. The resulting water permeate which emerges from the HERO system is an ultra-pure, deionized water that is suitable for use in semiconductor fabrication processes, for example.

### BRIEF DESCRIPTION OF THE DRAWINGS

The invention will now be described, by way of example, with reference to the accompanying drawings, in which:

FIG. 1 is a schematic of a typical conventional water purification system which incorporates a high-efficiency reverse osmosis (HERO) system; and

FIG. 2 is a schematic of a water purification system having a dosing system incorporated therein in accordance with the present invention.

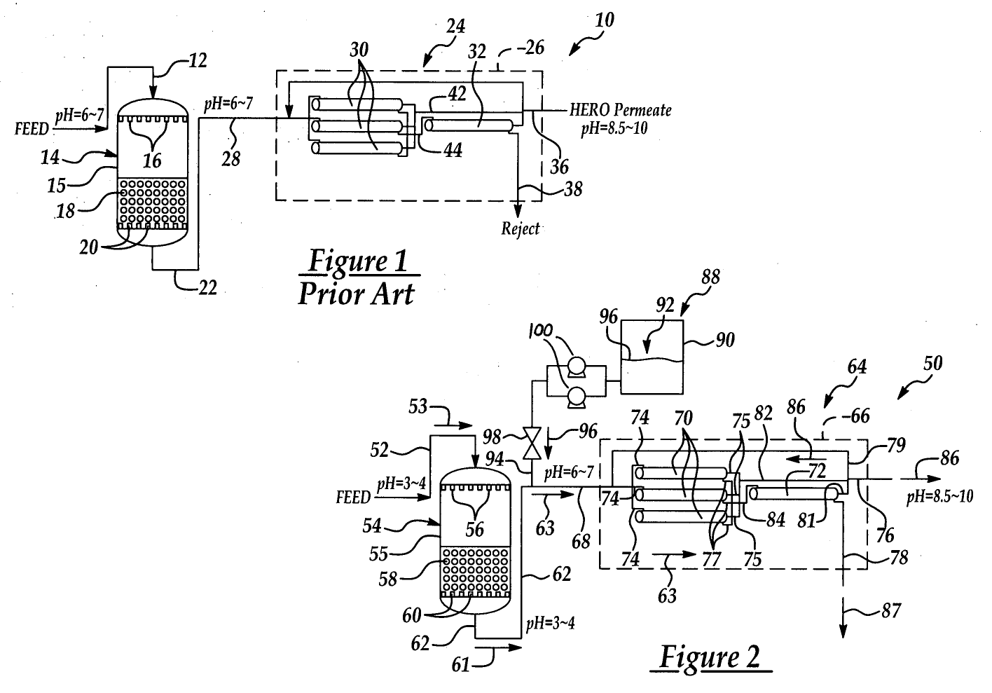

### DETAILED DESCRIPTION OF THE INVENTION

The present invention contemplates a water purification system having a base dosing system for rapidly raising the pH of acidic wastewater, typically from semiconductor fabrication processes, as the wastewater flows from an ion exchange unit to a high-efficiency reverse osmosis (HERO) system. The present invention further includes a base dosing method for raising the pH of acidic wastewater during treatment of the wastewater. The base dosing system includes a base dispensing tank that contains a sodium hydroxide solution of high concentration. The sodium hydroxide is dispensed into the wastewater as the wastewater flows from an ion exchange unit, raising the pH of the wastewater from about 3˜4 to about 6˜7 prior to entry of the wastewater into a HERO system. The HERO system further raises the pH of the wastewater to about 8.5˜10. The resulting purified, de-ionized water is suitable for use in semiconductor fabrication processes, for example. However, it is understood that the system and method of the present invention is equally applicable to purifying wastewater in other industries.

Referring to FIG. 2, wherein a water purification system having a dosing system in accordance with the present invention is generally indicated by reference numeral 50. In a typical embodiment, the system 50 includes an inlet line 52 that receives raw wastewater 53 typically from one or various semiconductor facbrication processes. For example, the wastewater 53 may include wastewater from a chemical mechanical planarization (CMP) process or a wafer-rinsing or cleaning process, for example.

The inlet line 52 is provided in fluid communication with a tank 55 of an ion exchange unit 54. Multiple inlet nozzles 56, which are provided in fluid communication with the inlet line 52, are typically provided in the upper portion of the tank 55. An ion exchange resin bed 58 is provided in the bottom portion of the tank 55 for the removal of both positive and negative ions from the wastewater 53 in a first wastewater treatment process, as hereinafter described. Multiple outlet nozzles 60 are provided in the bottom of the tank 55, at the bottom of the ion exchange resin bed 58. An ion exchange outlet line 62, which communicates with the outlet nozzles 60, extends typically from the bottom of the tank 55 to distribute the partially-treated wastewater 61 from the tank 55.

A HERO system inlet line 68 extends from the ion exchange outlet line 62 and enters a HERO (high-efficiency reverse osmosis) system 64, which will be herinafter described. A base dosing system 88 includes a base dispensing tank 90 having a tank interior 92 for containing a sodium hydroxide aqueous solution of high concentration. A dispensing conduit 94 extends from the base dispensing tank 90 and is disposed in fluid communication with the HERO system inlet line 68. A valve 98 is typically provided in the dispensing conduit 94 to control the quantity and rate of base 96 dispensed from the tank interior 92 to the HERO system inlet line 68, as hereinafter described. One or multiple pumps 100 may be provided between the base dispensing tank 90 and the dispensing conduit 94 to pump the base 96 from the base dispensing tank 90 to the dispensing conduit 94.

The HERO system 64 typically includes a housing 66 into which the HERO system inlet line 68 extends. Multiple first stage filter membranes 70 are provided in fluid communication with the HERO system inlet line 68 through respective first stage inlet lines 74. Multiple first stage permeate outlet lines 75 lead from the respective first stage filter mambranes 70 to a second stage bypass line 82 which communicates with a main permeate outlet line 76. Multiple stage transfer lines 77 extend from the respective first stage filter membranes 70 to a second stage inlet line 84, which leads into a second stage filter membrane 72. A second stage outlet line 81 and a reject outlet line 78 extend from the outlet end of the second stage filter membrane 72. A permeate feedback line 79 may extend from the main permeate outlet line 76 to the HERO system inlet line 68. A filter bypass line 80 may extend directly from the HERO system inlet line 68 to the reject outlet line 78.

In operation of the water purification system 50, raw wastewater 53 enters the tank 55 of the ion exchange unit 54 through the inlet line 52 and inlet nozzles 56, respectively. Typically, the raw wastewater 53 is distributed into the tank 55 in batches, rather than as a continuous flow. As the wastewater 53 is typically pulled by gravity through the ion exchange resin bed 58, large cations and anions, such as Ca⁺⁺ and SO₄⁻, bind to the resins in the resin bed 58 and are removed from the wastewater 53. The partially-purified wastewater 61 passes from the tank 55 through the outlet nozzles 60 and ion exchange outlet line 62, respectively.

The partially-purified wastewater 61 from the ion exchange unit 54 passes into the HERO system 64 through the HERO system inlet line 68. As the partially-treated wastewater 61 flows through the HERO system inlet line 68 toward the HERO system 64, sodium hydroxide aqueous base solution 96 is dispensed from the base-dispensing tank 90, through the dispensing conduit 94 and into the HERO system inlet line 68, typically by operation of the pump or pumps 100. In the HERO system inlet line 68, the base solution 96 mixes with the partially-treated wastewater 61 from the ion exchange unit 54, and forms neutralized or almost-neutralized wastewater 63. The wastewater 63 flows into the HERO system 64 through the HERO system inlet line 68.

Some of the wastewater 63 flows from the HERO system inlet line 68, into the first stage filter membranes 70 through the respective first stage inlet lines 74; from the first stage filter membranes 70, through the respective first stage permeate outlet lines 75 and into the second stage bypass line 82; and from the second stage bypass line 82 into the main permeate outlet line 76, respectively. The permeate outlet line 76 distributes the purified wastewater 86 from the HERO system 64. The rest of the partially-treated and neutralized wastewater 63 flows from the first stage filter membranes 70 through the respective stage transfer lines 77, through the second stage inlet line 84 and into the second stage filter membrane 72, respectively.

After it flows through the second stage filter membrane 72, most of the purified wastewater permeate 86 leaves the second stage filter membrane 72 through the second stage outlet line 81 and the HERO system 64 through the main permeate outlet line 76, respectively. A portion of the wastewater permeate 86 may be diverted through the permeate feedback line 79, back to the HERO system inlet line 68, and added to the partially-treated wastewater 63 therein.

A portion of the partially-treated wastewater 63 is distributed from the HERO system inlet line 68, through the filter bypass line 80 and into the reject outlet line 78. The reject outlet line 78 distributes ions removed or rejected from the first stage filter membranes 70 and second stage filter membranes 72, from the second stage filter membrane 72. In the reject outlet line 78, the diverted wastewater 63 dilutes the rejected ions and is discharged from the reject outlet line 78 as reject fluid 87.

As the partially-purifed and neutralized wastewater 63 flows through the first stage filters 70 or through both the first stage filters 70 and the second stage filter 72, ions which were not removed from the wastewater 53 in the ion exchange unit 54 are removed from the wastewater 63. The wastewater permeate 86 which emerges from the HERO system 64 through the main permeate outlet line 76 is substantially de-ionized. The ions removed from the wastewater 63 by the first stage filters 70 and second stage filter 72 are discharged typically through the reject outlet line 78, as heretofore described.

The raw wastewater 53 which enters the ion exchange unit 54 has an acidic pH of typically about 3˜4. This same pH is maintained as the water leaves the ion exchange unit 54 and enters the HERO system inlet line 68. In the HERO system inlet line 68, a sufficient quantity of aqueous base solution 96 is added to the partially-treated wastewater 61 to raise the pH of the wastewater 61 from typically about 3˜4 to typically about 6˜7. This quantity of base solution 96 will vary depending on the volume of wastewater 53 being batch-treated through the water purification system 88, as well as the concentration of the aqueous base solution 96.

The first stage filter membranes 70 and the second stage filter membrane 72 in the HERO system 64 are typically negatively-charged. Accordingly, anions are rejected from the wastewater by the negatively-charged filter membranes 70, 72. Consequently, hydronium (H⁺) ions remaining in the wastewater, unbound by the removed anions, are free to react with hydroxide (OH⁻) ions remaining in the water, thereby raising the pH of the water. As a result, the pH of the purified wastewater permeate 86 leaving the HERO system 64 through the main permeate outlet line 76 has a pH of typically about 8.5˜10. This purified wastewater permeate 86 has a purity which renders the permeate 86 suitable for semiconductor fabrication processes or other industrial processes.

While the preferred embodiments of the invention have been described above, it will be recognized and understood that various modifications can be made in the invention and the appended claims are intended to cover all such modifications which may fall within the spirit and scope of the invention.

1. A water purification system for purifying wastewater, comprising:
an ion exchange unit for removing ions from the wastewater;
a base dosing system provided in fluid communication with said ion exchange unit for raising a pH of the wastewater; and
a high-efficiency reverse osmosis system provided in fluid communication with said base dosing system for removing ions from the wastewater.

2. The water purification system of claim 1 wherein said base dosing system comprises a base dispensing tank for containing a base solution and a dispensing conduit extending from said base dispensing tank for dispensing the base solution into the wastewater.

3. The water purification system of claim 1 wherein said ion exchange unit comprises a tank and an ion exchange resin bed provided in said tank.

4. The water purification system of claim 3 wherein said base dosing system comprises a base dispensing tank for containing a base solution and a dispensing conduit extending from said base dispensing tank for dispensing the base solution into the wastewater.

5. The water purification system of claim 1 wherein said high-efficiency reverse osmosis system comprises at least one first stage filter membrane and at least one second stage filter membrane provided in fluid communication with said base dosing system.

6. The water purification system of claim 5 wherein said base dosing system comprises a base dispensing tank for containing a base solution and a dispensing conduit extending from said base dispensing tank for dispensing the base solution into the wastewater.

7. The water purification system of claim 5 wherein said ion exchange unit comprises a tank and an ion exchange resin bed provided in said tank.

8. The water purification system of claim 7 wherein said base dosing system comprises a base dispensing tank for containing a base solution and a dispensing conduit extending from said base dispensing tank for dispensing the base solution into the wastewater.

9. A water purification system for purifying wastewater, comprising:
an ion exchange unit for removing ions from the wastewater;
a base dosing system comprising at least three first stage membranes and a second stage membrane provided in fluid communication with said ion exchange unit for raising a pH of the wastewater; and
a high-efficiency reverse osmosis system provided in fluid communication with said base dosing system for removing ions from the wastewater.

10. The water purification system of claim 9 wherein said base dosing system comprises a base dispensing tank for containing a base solution and a dispensing conduit extending from said base dispensing tank for dispensing the base solution into the wastewater.

11. The water purification system of claim 9 wherein said ion exchange unit comprises a tank and an ion exchange resin bed provided in said tank.

12. The water purification system of claim 11 wherein said base dosing system comprises a base dispensing tank for containing a base solution and a dispensing conduit extending from said base dispensing tank for dispensing the base solution into the wastewater.

13. The water purification system of claim 11 further comprising a plurality of inlet nozzles provided above said ion exchange resin bed for distributing the wastewater onto said ion exchange resin bed and a plurality of outlet nozzles provided beneath said ion exchange resin bed for distributing the wastewater from said tank.

14. The water purification system of claim 13 wherein said base dosing system comprises a base dispensing tank for containing a base solution and a dispensing conduit extending from said base dispensing tank for dispensing the base solution into the wastewater.

15. A method of purifying wastewater, comprising the steps of:
providing an ion exchange unit;
providing a high-efficiency reverse osmosis system in fluid communication with said ion exchange unit;
distributing the wastewater through said ion exchange unit;
raising the pH of the wastewater in a first step; and
raising the pH of the wastewater in a second step by distributing the wastewater through said high-efficiency reverse osmosis system.

16. The method of claim 15 wherein said raising the pH of the water in a first step comprises raising the pH of the water from a pH of about 3 to 4 to a pH of about 6 to 7.

17. The method of claim 16 wherein said raising the pH of the water in a second step comprises raising the pH of the water from said pH of about 6 to 7 to a pH of about 8.5 to 10.

18. The method of claim 15 wherein said raising the pH of the wastewater in a first step comprises providing an inlet line between and in fluid communication with said ion exchange unit and said high-efficiency reverse osmosis system, providing a base dosing system in fluid communication with said inlet line, distributing the wastewater through said inlet line, and dispensing a base from said base dosing system into said inlet line.

19. The method of claim 18 wherein said raising the pH of the water in a first step comprises raising the pH of the water from a pH of about 3 to 4 to a pH of about 6 to 7.

20. The method of claim 19 wherein said raising the pH of the water in a second step comprises raising the pH of the water from said pH of about 6 to 7 to a pH of about 8.5 to 10.
